(19) United States
(12) Patent Application Publication
(10) Pub. No.: US 2015/0350641 A1
(43) Pub. Date: Dec. 3, 2015

(54) DYNAMIC RANGE ADAPTIVE VIDEO CODING SYSTEM

(71) Applicant: Apple Inc., Cupertino, CA (US)

(72) Inventors: Xiaosong Zhou, Campbell, CA (US); Jiefu Zhai, San Jose, CA (US); Yeping Su, Sunnyvale, CA (US); Chris Y. Chung, Sunnyvale, CA (US); Hsi-Jung Wu, San Jose, CA (US)

(21) Appl. No.: 14/636,839

(22) Filed: Mar. 3, 2015

Related U.S. Application Data
(60) Provisional application No. 62/004,604, filed on May 29, 2014.

(51) Int. Cl. H04N 19/105; H04N 19/159; H04N 19/13; H04N 19/176; H04N 19/18; H04N 19/119; H04N 19/167

(52) U.S. Cl. CPC H04N 19/105; H04N 19/119; H04N 19/159; H04N 19/167; H04N 19/176; H04N 19/18; H04N 19/13

(57) ABSTRACT

A video coding/decoding system codes data efficiently even when input video data exhibits changes in dynamic range. The system may map pixel values of the first frame from a dynamic range specific to the input image data to a second dynamic range that applies universally to a plurality of frames that have different dynamic ranges defined for them. The system may code the mapped pixel values to reduce bandwidth of the mapped frame data, and thereafter transmit the coded image data to a channel.

### CROSS-REFERENCE TO RELATED APPLICATIONS

The present application benefits from priority afforded by U.S. application Ser. No. 62/004,604, filed May 29, 2014, the disclosure of which is incorporated herein by reference.

### BACKGROUND

The present disclosure relates to video coding systems and, in particular, to techniques for efficient coding of video data that have different dynamic ranges associated with different frames.

Video data typically is comprised of a time-ordered sequence of frames where each frame includes a spatial array of pixels. Video data often is generated by an image capture device which may include an image sensor and an electronically-controlled optical system that focuses light on the sensor. The optical system may include an array of lenses, irises and other optical components that control how much light is incident on the sensor and how it is focused. The control system may include auto-exposure, auto-focus and other controls that define operational parameters within the sensor and the optical system. These operational parameters may vary, of course, if the character of the incoming light changes due to, for example, changes in ambient light when the image capture device is being used, or movement among objects being imaged and the like. The image capture device may output digital data representing values of pixels that are captured in each frame of the video data.

Changing operational parameters may cause changes in the dynamic range of each frame. Dynamic range refers generally to a difference between the quantity of light represented by the smallest pixel value in a frame and the quantity of light represented by the largest pixel value in the same frame. In an example, where a pixel is represented by an 8-bit value, the smallest digital value (2⁰=1) may represent a certain quantity of light at a given operational setting of an image capture system. Any pixel that captures an amount of light at or below that minimum quantity may output a value equal to this minimum value. Similarly, in this example, the largest digital value (2⁸−1=255) may represent another quantity of light at the operational setting of the image capture system. Any pixel that captures an amount of light at or above that maximum quantity will output a value equal to the maximum value. Thus, the dynamic range of the image capture system limits the range of values that may be represented by a digital output.

When operational settings of an image capture system change, the amounts of light represented by these maximum and minimum digital values also change. A pixel value representing a “1” may represent a first quantity of light for a first operational setting but a second quantity of light for a second operational setting. Similarly, pixel value representing “255” may represent different quantities of light for a first operational setting and a second operational setting. The operational settings cause changes in the dynamic ranges of the signals represented by the digital pixel values.

Video coding systems attempt to code video data in a manner that reduces the bit rate of video data. Typically, those systems exploit spatial and/or temporal redundancies in image data. Coding systems attempt to identify prediction references for image data by searching, given a new frame of video data to be coded, for previously-coded video data that approximates the content of the new frame. When such prediction references are identified, coding operations can efficiently represent the content of the new frame. When such predictions references are not identified, coding operations typically incur larger expense to code new content because additional data is required to represent the frame in a coded bit stream.

Predictive coding operations also develop state models between an encoder and a decoder which are updated incrementally as they exchange data regarding predictively-coded frames. These state models also contribute to efficient coding of video data.

When the dynamic range of video content changes, it interrupts efficient coding of video. Typically, a frame of video data that has a dynamic range that is changed over previously-coded frames will not yield good prediction matches through a traditional search. Oftentimes, the frame cannot be coded predictively. Moreover, coding of a frame with a changed dynamic range often requires an encoder to reset the coding state of its decoder. In the parlance of the MPEG-4 coding standard, the encoder would have to send an instantaneous decoder refresh (IDR) frame, which causes a decoder to reset its state models. The coding of IDR frames typically is among the least efficient coding techniques available in a coding system.

The inventors perceive a need in the art that accommodates coding of video data with changing dynamic ranges but without incurring the expense of known techniques. For example, the inventors perceive a need to avoid sending IDR frames when changes in dynamic range occur.

### BRIEF DESCRIPTION OF THE DRAWINGS

FIG. 1 is a simplified block diagram of an encoder/decoder system according to an embodiment of the present disclosure.

FIG. 2 is a functional block diagram of an encoding and decoding terminal according to an embodiment of the present disclosure.

FIG. 3 illustrates a method according to an embodiment of the present disclosure.

FIG. 4 schematically illustrates a universal dynamic range definition and dynamic range definitions for video data, according to an embodiment of the present disclosure.

FIG. 5 illustrates another method according to another embodiment of the present disclosure.

FIG. 6 schematically illustrates a universal dynamic range definition and dynamic range definitions for video data, according to another embodiment of the present disclosure.

FIG. 7 illustrates another method according to an embodiment of the present disclosure.

### DETAILED DESCRIPTION

Embodiments of the present disclosure provide techniques to code and decode video data in which pixel values of a first frame of the video data may be mapped from a dynamic range specific to the first frame to a second dynamic range that applies universally to a plurality of frames in the video data that have different dynamic ranges defined for them. Thereafter, the mapped pixel values may be coded to reduce bandwidth of the mapped frame data, and the coded image data may be transmitted to a channel. In this manner, the coding system may accommodate changes in dynamic range of individual frames without requiring an IDR frame or other coding constructs that incur heavy expense for coding.

FIG. 1 is a simplified block diagram of an encoder/decoder system 100 according to an embodiment of the present disclosure. The system 100 may include first and second terminals 110, 120 interconnected by a network 130. The terminals 110, 120 may exchange coded video data with each other via the network 130, either in a unidirectional or bidirectional exchange. For unidirectional exchange, a first terminal 110 may capture video data from local image content, code it and transmit the coded video data to a second terminal 120. The second terminal 120 may decode the coded video data that it receives and display the decoded video at a local display. For bidirectional exchange, each terminal 110, 120 may capture video data locally, code it and transmit the coded video data to the other terminal. Each terminal 110, 120 also may decode the coded video data that it receives from the other terminal and display it for local viewing.

Although the terminals 110, 120 are illustrated as smartphones in FIG. 1, they may be provided as a variety of computing platforms, including servers, personal computers, laptop computers, tablet computers, media players and/or dedicated video conferencing equipment. The network 130 represents any number of networks that convey coded video data among the terminals 110, 120, including, for example, wireline and/or wireless communication networks. A communication network 130 may exchange data in circuit-switched and/or packet-switched channels. Representative networks include telecommunications networks, local area networks, wide area networks and/or the Internet. For the purposes of the present discussion, the architecture and topology of the network 130 are immaterial to the present disclosure unless discussed hereinbelow.

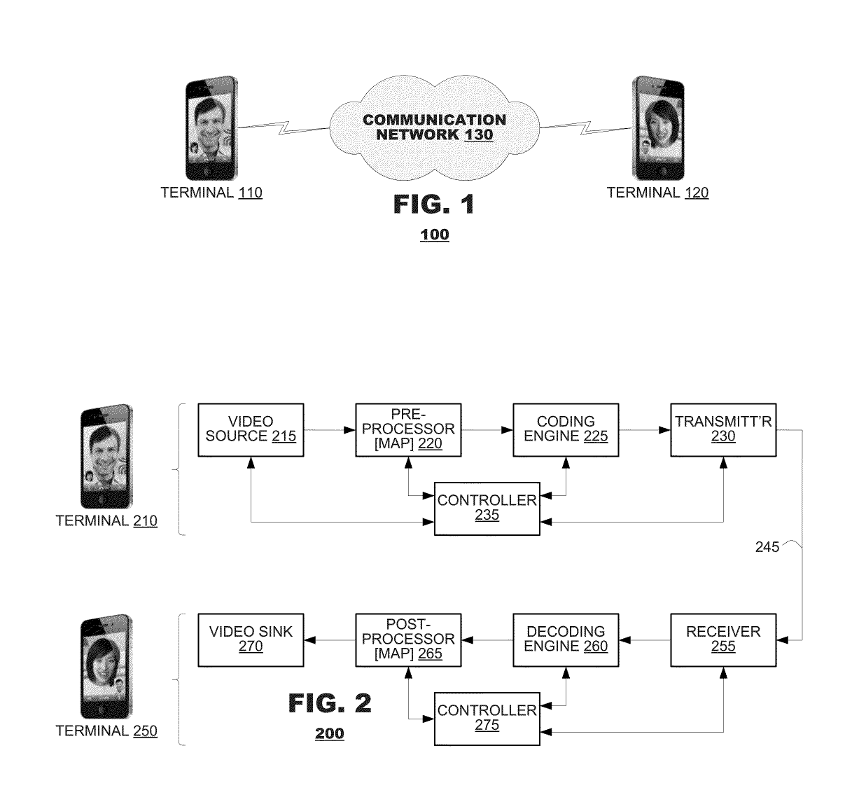

FIG. 2 is a functional block diagram of a terminal 210 that performs video coding according to an embodiment of the present disclosure. The terminal 210 may include a video source 215, a preprocessor 220, a coding engine 225, a transmitter 230 and a controller 235. The video source 215 may generate a video sequence for coding. The preprocessor 220 may perform various processing operations that condition the input signal for coding, which in an embodiment may include dynamic range mapping as discussed below. The coding engine 225 may perform data compression operations to reduce the bitrate of the video sequence output from the preprocessor 220. The transmitter 230 may transmit coded video data to another terminal 250 via a channel 245 provided by a network. The controller 235 may coordinate operation of the terminal 210 as it performs these functions.

Typical video sources 215 include image capture systems, such as cameras, that generate video from locally-captured image information. They also may include storage devices in which video may be stored, e.g., for authoring applications and/or media-serving applications. Thus, source video sequences may represent naturally-occurring image content or synthetically-generated image content (e.g., computer generated video) as application needs warrant. The video source may provide source video to other components within the terminal 210.

As indicated, the preprocessor 220 may perform video processing operations upon the camera video data to improve quality of the video data or to condition the video data for coding. As discussed hereinbelow, the preprocessor 220 may perform mapping operations for dynamic range of image data. Optionally, the preprocessor 220 may perform other processes to improve quality of the video data such as motion stabilization and/or filtering. Filtering operations may include spatial filtering, temporal filtering, and/or noise detection and removal.

The coding engine 225 may code frames of video data to reduce bandwidth of the source video. In an embodiment, the coding engine 225 may perform preprocessing, content prediction and coding. Preprocessing operations typically condition a video sequence for subsequent coding. Typical preprocessing may include filtering operations that alter the spatial and/or temporal complexity of the source video, resizing operations that alter the size of frames within the source video and frame rate conversion operations that alter the frame rate of the source video. Such preprocessing operations also may vary dynamically according to operating states of the terminal 210, operating states of the network 130 (FIG. 1) and/or operating states of a second terminal 250 that receives coded video from the first terminal 210. In some operating states, preprocessing may be disabled, in which case, the prediction and coding may be performed on video data output by the preprocessor 220 without alteration.

Prediction and coding operations may reduce the bandwidth of the video sequence by exploiting redundancies in the source video's content. For example, coding may use content of one or more previously-coded “reference frames” to predict content for a new frame to be coded. Such coding may identify the reference frame(s) as a source of prediction in the coded video data and may provide supplementary “residual” data to improve image quality obtained by the prediction. Coding may operate according to any of a number of different coding protocols, including, for example, MPEG-4, H.263, H.264 and/or HEVC. Such coding operations typically involve executing a transform on pixel data to another data domain as by a discrete cosine transform or a wavelet transform, for example. Transform coefficients further may be quantized by a variable quantization parameter and entropy coding. Each protocol defines its own basis for parsing input data into pixel blocks prior to prediction and coding. The principles of the present disclosure may be used cooperatively with these approaches.

The coding operations may include a local decoding of coded reference frame data. Many predictive coding operations are lossy operations, which causes decoded video data to vary from the source video data in some manner. By decoding the coded reference frames, the terminal 210 stores a copy of the reference frames as they will be recovered by the second terminal 250.

The transmitter 230 may format the coded video data for transmission to another terminal. Again, the coding protocols typically define a syntax for exchange of video data among the different terminals. Additionally, the transmitter 230 may package the coded video data into packets or other data constructs as may be required by the network. Once the transmitter 230 packages the coded video data appropriately, it may release the coded video data to the network 130 (FIG. 1).

The coding engine 225 may select various coding parameters based on constraints that may be imposed upon it by a controller 235. For example, the coding engine 225 may select coding modes for frames and pixel blocks (for example, selection among inter-coding and intra-coding), quantization parameters and other coding parameters for various portions of the video sequence. The controller 235 may impose constraints on the coding engine 225 by selecting, for example, a target bit rate that the coded video must meet and/or a metric of image quality that must be met when the coded video is decoded. In this manner, the elements of the coding engine 225 operate cooperatively with the controller 235.

FIG. 2 also illustrates functional units of a second terminal 250 that decodes coded video data according to an embodiment of the present disclosure. The terminal 250 may include a receiver 255, a decoding engine 260, a post-processor 265, a video sink 270 and a controller 275. The receiver 255 may receive coded video data from the channel 245 and provide it to the decoding engine 260. The decoding engine 260 may invert coding operations applied by the first terminal's coding engine 225 and may generate recovered video data therefrom. The post-processor 265 may perform signal conditioning operations on the recovered video data from the decoding engine 260, including dynamic range mapping as discussed below. The video sink 270 may render the recovered video data. The controller 275 may manage operations of the terminal 250.

As indicated, the receiver 255 may receive coded video data from a channel. The coded video data may be included with channel data representing other content, such as coded audio data and other metadata. The receiver 255 may parse the channel data into its constituent data streams and may pass the data streams to respective decoders (not shown), including the decoding engine 260.

The decoding engine 260 may generate recovered video data from the coded video data. The decoding engine 260 may perform prediction and decoding processes. For example, such processes may include entropy decoding, re-quantization and inverse transform operations that may have been applied by the encoder. The decoding engine 260 may build a reference picture cache to store recovered video data of the reference frames. Prediction processes may retrieve data from the reference picture cache to use for predictive decoding operations for later-received coded frames. The coded video data may include motion vectors or other identifiers that identify locations within previously-stored reference frames that are prediction references for subsequently-received coded video data. Decoding operations may operate according to the coding protocol applied by the coding engine 225 and may comply with MPEG-4, H.263, H.264 and/or HEVC.

The post-processor 265 may condition recovered frame data for rendering. As part of its operation, the post-processor 265 may perform dynamic range mapping as discussed hereinbelow. Optionally, the post-processor 265 may perform other filtering operations to improve image quality of the recovered video data.

The video sink 270 represents units within the second terminal 250 that may consume recovered video data. In an embodiment, the video sink 270 may be a display device. In other embodiments, however, the video sink 270 may be provided by applications that execute on the second terminal 250 that consume video data. Such applications may include, for example, video games and video authoring applications (e.g., editors).

FIG. 2 illustrates functional units that may be provided to support unidirectional transmission of video from a first terminal 210 to a second terminal 250. In many video coding applications, bidirectional transmission of video may be warranted. The principles of the present disclosure may accommodate such applications by replicating the functional units 215-235 within the second terminal 250 and replicating the functional units 255-275 within the first terminal 210. Such functional units are not illustrated in FIG. 2 for convenience.

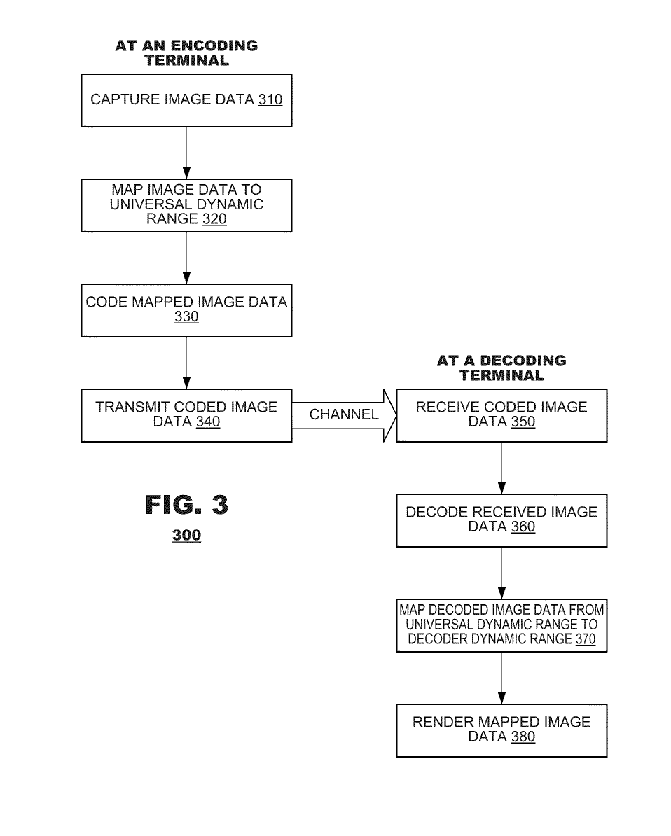

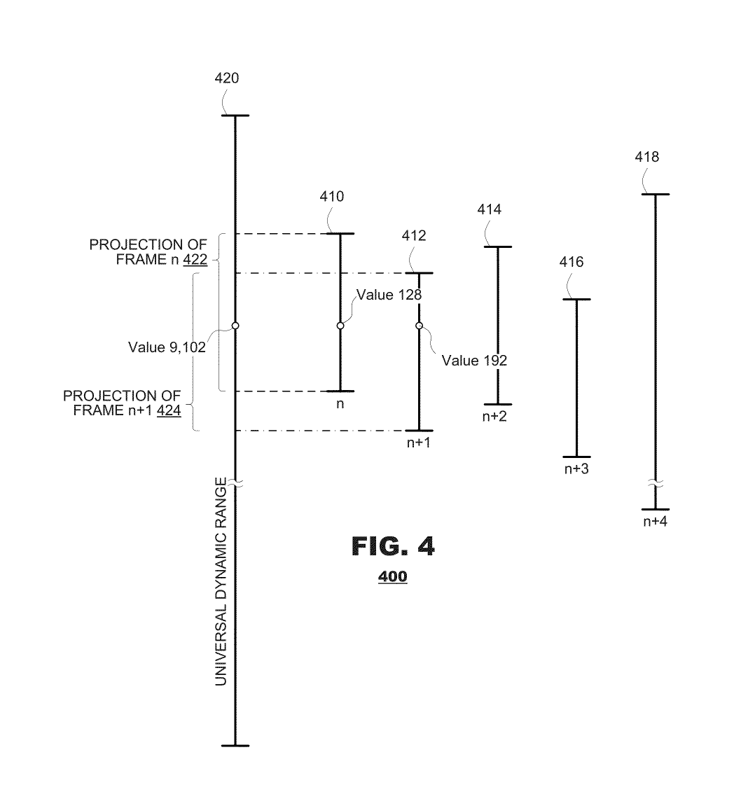

FIG. 3 illustrates a method 300 according to an embodiment of the present disclosure. Portions of the method 300 may be operational at an encoding terminal and other portions of the method 300 may be operational at a decoding terminal. The method 300 may begin with the capture of image data at the encoding terminal as part of a video sequence (box 310). The method 300 may map the image data to a universal dynamic range, which may alter values of the image data (box 320). Thereafter, the method 300 may code the mapped image data to reduce its bandwidth (box 330) and may transmit the coded image data to a channel (box 340).

At a decoding terminal, the method 300 may cause the coded image data to be received (box 350) and may decode the received image data (box 360). Thereafter, the method 300 may map the decoded image data from the universal dynamic range standard to a dynamic range that is appropriate for the decoding terminal (box 370). The method 300 may render the mapped image data (box 380).

As discussed, each frame of video data may have its own dynamic range defined for it or, alternatively, portions of a frame of video data may have a dynamic range defined for it that is different than the dynamic range(s) that are defined for other portions of the frame. In either case, the mapping operation of box 320 may cause each frame or portion thereof to be mapped to a universal dynamic range standard. Moreover, mapping at a decoder may cause decoded image data to be mapped to dynamic range(s) that are appropriate for the decoding terminal. For example, the dynamic range to which the image data is mapped may be defined by characteristics of display devices at the decoding terminal.

FIG. 4 schematically illustrates mapping operations 400 that may be applied during coding, according to an embodiment of the present disclosure. FIG. 4 illustrates five frames of video content n to n+4 that have different dynamic ranges 410-418 assigned to them. Although these frames are labeled in consecutive order, the frames need not be adjacent to each other in temporal order; it is permissible, for example, for other frames (not shown) that appear between frames n and n+1 that have dynamic ranges that match those of frames n or n+1.

Frames n to n+3 are illustrated as having a common bit depth. For example, pixel values in these frames may be 8-bit values, which can take values between 0 and 255. Owing to shifts in dynamic ranges among these frames, two pixels with identical content might have a value of 128 in frame n and a value of 192 in frame n+1. The content of the pixels may not have changed but operating conditions of the image capture system (for example, exposure settings) may have changed the digital representation of the pixel as data.

The universal dynamic range 420 may have a bit depth that exceeds the expected dynamic ranges of all image data that is expected to be handled by an encoding terminal. For example, in a system where image data may be represented as 8- and/or 10-bit values (permitting pixel values of 0-255 or 0-1024 respectively), the bit depth of the universal dynamic range might be set to a 14- or 16-bit value (which permits values of 0-16,384 or 0-65,536, respectively).

A mapping of the frames n to n+4 may determine a projection of each frame's dynamic range onto a universal dynamic range. Thus, the dynamic range 410 of frame n may be represented as a first projection 422 onto the universal dynamic range. The dynamic range 412 of frame n+1 may be represented as a second projection 424 onto the universal dynamic range. Thus, in a situation where identical content is represented in two frames with different values owing solely to the differences in dynamic range (e.g., values 128 in frame n and value 192 in frame n+1), they may be mapped to a common value (e.g., value 9,102) on the universal dynamic range 420.

Projections of frames n+2 to n+4 are not illustrated in FIG. 4 but may be established in a similar manner.

Thus, the principles of the present disclosure permit video data to be coded with reference to a single “universal” definition of the dynamic range. By mapping image data to the universal dynamic range 420, the present disclosure permits the video data to be coded using a common definition of dynamic ranges. This permits an encoder to avoid use of IDRs (or its equivalents from other standards) when coding video data, which contributes to increased efficiency in the coding/decoding system.

In an embodiment, the universal dynamic range 420 may be defined between an encoding terminal and a decoding terminal before exchange of coded image data occurs. In an embodiment, the universal dynamic range 420 may be predefined by a coding protocol to which the encoding terminal and decoding terminal conform. In another embodiment, an encoding terminal may define parameters of the universal dynamic range 420 in a coded bit stream that is provided to the decoding terminal. In either case, the encoding terminal may refine the definition of the universal dynamic range 420 by providing updates to the decoding terminal in the coded bit stream throughout a video coding session.

In an embodiment, mapping may not occur for all data in a captured video frame. In many applications, frame data may undergo localized processes that alter its dynamic range before such frame data would be subject to mapping. For example, video data may be subject to processing by components of a video source 215 (FIG. 2) or in a pre-processor 220 that alter the dynamic range of frame data prior to mapping. The principles of the present disclosure may be used cooperatively with such systems.

Returning to FIG. 3, optionally, application of a universal dynamic range standard may involve changes to coding operations that are applied to image data. For example, coding of image data often involves a transform of pixel values to another information domain by a discrete cosine transform or a wavelet transform. The transform may generate transform coefficients which may be coded further by motion-compensated prediction, quantization and entropy coding. In an embodiment, quantization parameters may be adjusted according to the mapping applied to pixel values. Quantization parameters may be selected according to a scale of the universal dynamic range 420 (FIG. 4) rather than a scale of the source image's dynamic range 410. Thus, hypothetically, where 8-bit pixel values in the source image's dynamic range may be limited to values of 0-255, 16-bit pixel values in the universal dynamic range 420 may take values from 0-65,536. Quantization parameters may be scaled according to a ratio between the source image's dynamic range 410 and the universal dynamic range 420.

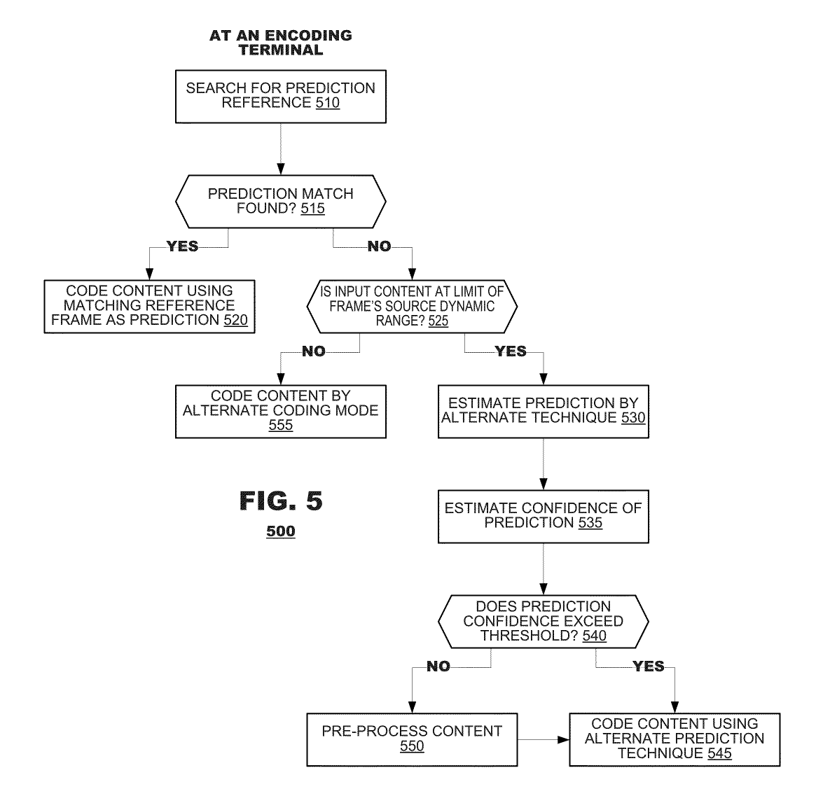

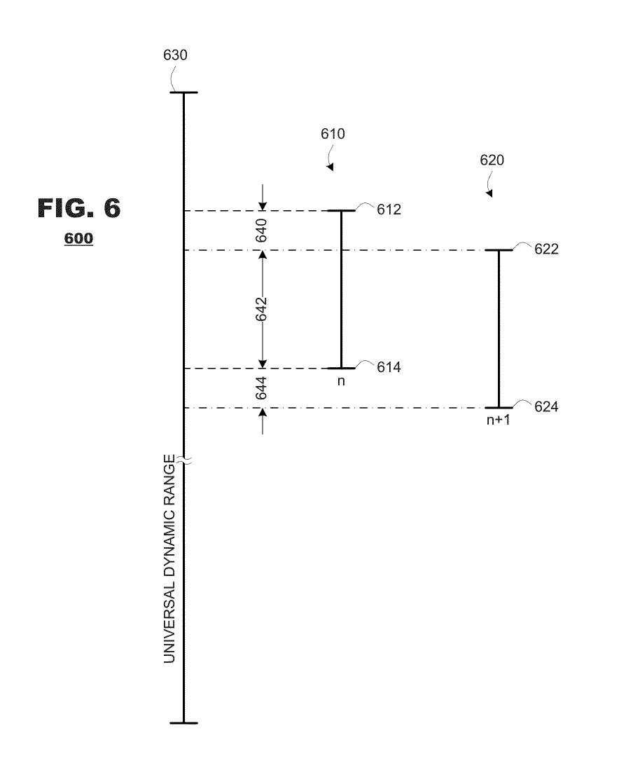

FIG. 5 illustrates a coding method 500 according to another embodiment of the present disclosure. According to the method 500, when new content is presented for coding, an encoding terminal may search for a prediction reference for the new content (box 510). The method 500 may determine whether a prediction match is found (box 515). If so, the method may code the new content using the matching reference frame as a source of prediction (box 520).

If no prediction match is identified, the method 500 may determine whether value(s) of the new content are at the limit of its frame's source dynamic range (box 525). If so, the method 500 may estimate a prediction source using an alternate prediction technique, one that does not rely on prediction searches (box 530). The method 500 also may estimate a confidence score for the prediction at box 530, representing an estimate whether the estimated prediction is accurate (box 535). The method 500 may compare the confidence score to a threshold (box 540). If the confidence score exceeds the threshold, the method 500 may code the new content using the prediction developed according to the alternate technique at box 530 (box 545). If the confidence score does not exceed the threshold, however, the method 500 may preprocess the content (box 550) prior to coding at box 545.

If, at box 525, value(s) of the new content were not at the limit of its frame's dynamic range, the method 500 may cause the new content to be coded according to an alternate coding mode, such as inter prediction (box 555).

The method 500 may operate anew for each new element of content to be coded by a coding terminal. In the HEVC coding standard, frames are parsed into “coding units” for coding. In the ITU H.263, H.264 and MPEG coding standards, frames are parsed into “macroblocks” and “blocks” for coding. The principles of FIG. 5 may be applied to any of these coding units, macroblocks and/or blocks as may be desired.

Alternatively, when a frame being coded has data values outside of a reference frame's dynamic range, an encoder can use the reference frame as prediction to get more efficient coding of the overlapping data range. Moreover, when a reference frame has data values outside of the dynamic range of the frame being coded, an encoder may operate according to several techniques. In a first technique, an encoder may clip a prediction from the reference frame to match the dynamic range of the frame being coded. Alternatively, the encoder may use values from the prediction without clipping. Indeed, the encoder may select between these techniques based on the confidence estimates it derives (box 535).

FIG. 6 illustrates scenarios where alternate predictions may be performed because input content is at the limit of its frame's dynamic range, as represented in box 525 (FIG. 5). FIG. 6 illustrates dynamic ranges 610, 620 of two frames, labeled n and n+1. The dynamic range of 610 may have an upper limit 612 and a lower limit 614. During image capture, values of image data output by an image capture system may be limited to values between these limits 612, 614 owing to operational settings of the camera system. Any pixel value that otherwise would exceed the upper limit 612 may be clipped at the upper limit 612 and, similarly, any pixel value that otherwise would fall below the lower limit 614 may be clipped at the lower limit. The dynamic range 620 of frame n+1 also may have respective upper and lower limits 622, 624; pixel values that otherwise would go beyond either of these limits 622, 624 would be clipped at those limits as discussed with regard to frame n.

When the dynamic ranges 610, 620 of the frames n and n+1 are projected onto a universal dynamic range 630, the limits 612, 614, 622 and 624 define certain zones of overlap. A first zone 640 represents a portion of the dynamic range 610 of frame n that exceeds the upper limit 622 of the dynamic range 620 of frame n+1. A second zone 642 represents a zone where the dynamic ranges 610, 620 of frames n and n+1 overlap each other. A third zone 644 represents a portion of the dynamic range 620 of frame n+1 that exceeds a lower limit 614 of the dynamic range 610 of frame n.

Consider an example where new content from frame n+1 is to be coded and content from frame n is available for use as a prediction reference for the content of frame n+1. If a prediction reference is not found at box 515 (FIG. 5) but the content has a value at the upper limit 622 of its frame's dynamic range 620, then it is possible that an appropriate prediction reference for the new content is available from content of frame n whose values reside within zone 640 of frame n's dynamic range 610. Because pixel values of frame n+1 are clipped at the upper limit 622, however, such prediction references may not be identified through a traditional prediction search process (box 510). In this case, the method 500 may estimate a prediction source for the new content via an alternate technique.

Similar operations may occur for image data that resides at the lower limit of a frame's dynamic range. Consider a different example, where content of frame n may be predicted from frame n+1. If a prediction reference is not found at box 515 (FIG. 5) but the content of frame n has a value at the lower limit 614 of its frame's dynamic range 610, then it is possible that an appropriate prediction reference for the new content of frame n is available from content of frame n+1 whose values reside within zone 644 of frame n+1's dynamic range 620. Because pixel values of frame n are clipped at the lower limit 614, however, such prediction references may not be identified through a traditional prediction search process (box 510). In this case, the method 500 may estimate a prediction source for the new content via an alternate technique.

Consider an example where a current frame captures a ceiling light that causes a region of a frame to be overexposed—it loses all the details in area corresponding to the ceiling light—but a reference frame captured all the details of that region because it was captured under different exposure settings. Once both frames are mapped to the universal dynamic range, the details of the ceiling light likely will be outside the dynamic range of the current frame. An encoder, however, may use image content of the ceiling light from the reference frame to predictively code image information for the region in the current frame occupied by the celling light. The encoder may provide such details via prediction without clipping if the encoder is confident that this is a well-matched prediction. In this case, the reconstructed version of the current frame will also have those details and the dynamic range of the frame being coded effectively will be increased. On the other hand, if the encoder develops a low confidence estimate, the encoder may clip image information in the region occupied by the ceiling light, or may apply some filtering to the details so that they blend into current frame better.

The alternate prediction techniques represented by box 545 (FIG. 5) may be performed in a variety of ways. In one embodiment, the method 500 may derive a prediction reference for the new content from prediction references that are established for other elements of content from a common frame. When coding a new content unit, for example, prediction references may have been developed for neighboring content units of a common frame. The method 500 may infer a prediction reference for the new content unit from the prediction references of the neighboring content units. Alternatively, the method 500 may infer a prediction reference for the new content unit from an estimation of global motion in the frame in which the content unit resides.

In another embodiment, the method 500 may infer a prediction reference for new content from an estimate of geometric transforms that are present in a frame. Frames may be subject to object detection processes (such as face detection), which detect from image content objects of certain types, the locations and sizes of those objects. When the sizes of those objects are identified as changing, it can indicate that the depth of those objects changing within the image content (e.g., the object has drawn nearer or farther away from a camera) or that the orientation of the object has changed (e.g., due to rotation). Thus, prediction reference estimates can account for detected transformations of image content provided by these object detection processes.

Confidence estimates represented by box 535 (FIG. 5) also can be performed in a variety of ways. The method 500 may compare content of the prediction data to content of content elements that are spatially adjacent to the content element being coded to identify disparities in characteristics such as color and/or spatial complexity. If, for example, predicted content has strong high frequency content but adjacent content elements do not, it may indicate that the estimated prediction is in error, which may yield a low confidence estimate. The method 500 may compare content of the prediction data to content of co-located content from other frames to identify disparities in characteristics such as color and content duration. If, for example, predicted content has average color value that is different from co-located content in adjacent frames, it may indicate that the estimated prediction is in error. In another embodiment, confidence estimates may be derived from motion vector fields generated from motion estimation processes; when a motion field is consistent across a number of frames, it yields a confidence estimate that indicates an estimated prediction is a good prediction. In an embodiment, these estimates may be reduced to a numerical value representing a confidence score, which may be compared to a threshold value in box 540.

Preprocessing in box 550 (FIG. 5) may be performed to reduce the likelihood that visual artifacts will be introduced as a result of prediction in circumstances where there is low confidence that the prediction is correct. For example, source content may be filtered by smoothing filtering or other processes that reduce high frequency content prior to the coding. Filtering of high-frequency components of the content may reduce the likelihood that visual artifacts will arise due to mismatch with other elements of image content.

In other embodiments, preprocessing may be performed at different levels based on a confidence score. For example, in cases of extremely low confidence, the prediction attempt may be aborted altogether and the source content may be coded by an alternate coding mode as in box 555 (FIG. 5). In other cases, preprocessing filtering may be adjusted in strength according to a confidence score, applying relatively heavy levels of filtering for lower confidence scores and lower levels of filtering for higher confidence scores.

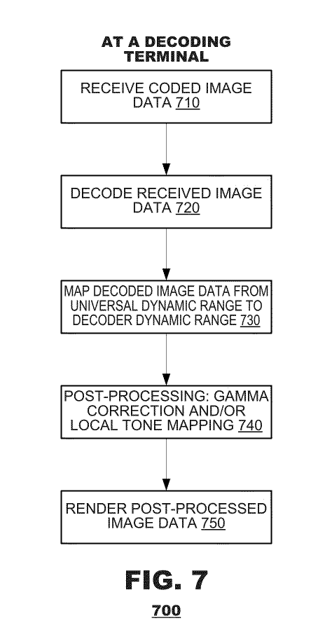

FIG. 7 illustrates another method 700 according to an embodiment of the present disclosure. The method 700 may be operable at a decoding terminal. The method 700 may begin when coded image data is received (box 710) and decoded (box 720). Decoded image data may be mapped from the universal dynamic range to a dynamic range that is appropriate for the decoding terminal (box 730). Again, the decoding terminal's dynamic range may be defined according to operational characteristics of the terminal's display or other devices at the terminal. Thereafter, the method 700 may perform post-processing operations on the mapped image data (box 740) and may render the processed image data at the terminal (box 750).

Post-processing may involve a variety of techniques, including gamma correction and/or local tone mapping. Gamma correction typically involves adjustments to image data to compensate for non-linearities in the image data that are introduced by an image capture system. Tone mapping typically involves a mapping of image data from a first color domain to another color domain to approximate the appearance of high dynamic range images in a medium that has a more limited dynamic range. Oftentimes, gamma correction and tone mapping are performed as a preprocessing operation in encoding terminals before coding. According to the embodiment of FIG. 7, such operations may be performed as a post-processing operation, after decoding and after dynamic range mapping in a decoding terminal.

The foregoing discussion has described operation of the embodiments of the present disclosure in the context of terminals that embody encoders and/or decoders. Commonly, these components are provided as electronic devices. They can be embodied in integrated circuits, such as application specific integrated circuits, field programmable gate arrays and/or digital signal processors. Alternatively, they can be embodied in computer programs that execute on personal computers, notebook computers, tablet computers, smartphones or computer servers. Such computer programs typically are stored in physical storage media such as electronic-, magnetic- and/or optically-based storage devices, where they are read to a processor under control of an operating system and executed. Similarly, decoders can be embodied in integrated circuits, such as application specific integrated circuits, field-programmable gate arrays and/or digital signal processors, or they can be embodied in computer programs that are stored by and executed on personal computers, notebook computers, tablet computers, smartphones or computer servers. Decoders commonly are packaged in consumer electronics devices, such as gaming systems, DVD players, portable media players and the like; and they also can be packaged in consumer software applications such as video games, browser-based media players and the like. And, of course, these components may be provided as hybrid systems that distribute functionality across dedicated hardware components and programmed general-purpose processors, as desired.

Several embodiments of the disclosure are specifically illustrated and/or described herein. However, it will be appreciated that modifications and variations of the disclosure are covered by the above teachings and within the purview of the appended claims without departing from the spirit and intended scope of the disclosure.

We claim:

1. A method, comprising:
responsive to a first frame of image data, mapping pixel values of the first frame from a first dynamic range specific to the image data to a second dynamic range, wherein the second dynamic range applies universally to a plurality of frames that have different dynamic ranges defined for them,
coding the first frame having the mapped pixel values to reduce its bandwidth, and
transmitting the coded frame to a channel.

2. The method of claim 1, further comprising repeating the mapping, the coding and the transmitting for a plurality of input frames, wherein the mapping causes pixel values from the respective input frames to be mapped from source dynamic ranges of the respective input frames to the second dynamic range.

3. The method of claim 1, wherein the coding comprises:
for a pixel block within the first frame, searching for a prediction reference for the pixel block,
when a prediction reference is not found, estimating a prediction reference for the pixel block from a non-search-based prediction technique, and
coding the pixel block using the prediction reference.

4. The method of claim 1, wherein the coding comprises:
for a pixel block within the first frame, determining whether the pixel block has pixel values at a limit of the first dynamic range,
estimating a prediction source for the pixel block from a portion of a reference frame having pixel values that exceed the limit of the first dynamic range,
estimating a confidence score associated with the estimated prediction source, and
when the confidence score exceeds a predetermined value, coding the pixel block using the prediction source as a prediction reference.

5. The method of claim 4, wherein the coding comprises, when a reference frame has pixel values outside of the first dynamic range, predicting image content for the first frame from the reference frame.

6. The method of claim 4, wherein the coding comprises, when a reference frame has pixel values outside of the first dynamic range,
predicting image content for the first frame from the reference frame, and
clipping the predicted image content, as necessary, to match the first dynamic range being coded.

7. The method of claim 1, wherein the coding comprises:
transforming mapped pixel values associated with the pixel block to a set of transform coefficients,
quantizing the transform coefficients according to a quantization parameter selected according to a ratio between the first dynamic range and the second dynamic range, and
entropy coding the quantized coefficients.

8. The method of claim 1, wherein the mapping increases a bit depth of each pixel value of the first frame.

9. A method, comprising:
receiving coded image data,
decoding the coded image data according to a predetermined protocol,
mapping the decoded image data from a first dynamic range that is defined for a plurality of frames of a video coding session to a second dynamic range that is specific to a decoding terminal in which the method is performed, and
rendering the mapped image data at the decoding terminal.

10. The method of claim 9, wherein the mapping decreases a bit depth of each pixel value of the decoded image data.

11. The method of claim 9, wherein the decoding comprises:
entropy decoding quantized coefficients in the coded image data,
scaling the entropy decoded coefficients according to a quantization parameter selected according to a ratio between the second dynamic range and the first dynamic range, and
transforming the scaled coefficients from a set of transform coefficients to a set of pixel values.

12. The method of claim 9, further comprising, following the mapping, performing gamma correction on the mapped image data.

13. The method of claim 9, further comprising, following the mapping, performing tone mapping on the mapped image data.

14. A computer readable medium having stored thereon program instructions that, when executed by a processing device, causes the processing device to execute a method comprising:
responsive to a first frame of image data, mapping pixel values of the first frame from a dynamic range specific to the image data to a second dynamic range, wherein the second dynamic range applies universally to a plurality of frames that have different dynamic ranges defined for them,
coding the first frame having the mapped pixel values to reduce its bandwidth, and
transmitting the coded frame to a channel.

15. The medium of claim 14, wherein program instructions cause the mapping, coding and transmitting to be repeated for a plurality of input frames, wherein the mapping causes pixel values from the respective input frames to be mapped from source dynamic ranges of the respective input frames to the second dynamic range.

16. The medium of claim 14, wherein the coding comprises:
for a pixel block within the first frame, searching for a prediction reference for the pixel block,
when a prediction reference is not found, estimating a prediction reference for the pixel block from a non-search based prediction technique, and
coding the pixel block using the prediction reference.

17. The medium of claim 14, wherein the coding comprises:
for a pixel block within the first frame, determining whether the pixel block has image data at a limit of the first frame's dynamic range,
estimating a prediction source for the pixel block from a portion of a reference frame having pixel values that exceed the limit of the first frame's dynamic range,
estimating a confidence score associated with the estimated prediction source, and
when the confidence score exceeds a predetermined value, coding the pixel block using the prediction source as a prediction reference.

18. The medium of claim 14, wherein the coding comprises:
transforming mapped pixel values associated with the pixel block to a set of transform coefficients,
quantizing the transform coefficients according to a quantization parameter selected according to a ratio between the first dynamic range and the second dynamic range, and
entropy coding the quantized coefficients.

19. The medium of claim 14, wherein the mapping increases a bit depth of each pixel value of the first frame.

20. A computer readable medium having stored thereon program instructions that, when executed by a processing device, causes the device to execute a method comprising:
decoding coded image data according to a predetermined protocol,
mapping the decoded image data from a first dynamic range that is defined for a plurality of frames of a video coding session to a second dynamic range that is specific to the processing device, and
rendering the mapped image data.

21. The medium of claim 20, wherein the mapping decreases a bit depth of each pixel value of the decoded image data.

22. The medium of claim 20, wherein the decoding comprises:
entropy decoding quantized coefficients in the coded image data,
scaling the entropy decoded coefficients according to a quantization parameter selected according to a ratio between the second dynamic range and the first dynamic range, and
transforming the scaled coefficients from a set of transform coefficients to a set of pixel values.

23. The medium of claim 20, further comprising, following the mapping, performing gamma correction on the mapped image data.

24. The medium of claim 20, further comprising, following the mapping, performing tone mapping on the mapped image data.

25. An apparatus, comprising:
a video source, providing frames of video data, wherein various frames of the video data have dynamic ranges identified for them that differ from dynamic ranges of other frames of the video data;
a preprocessor to map frames of video data from their respective dynamic ranges to a universal dynamic range that encompasses different dynamic ranges of a plurality of frames of the video data,
a coding engine to code the mapped frame data according to predictive coding techniques, and
a transmitter to transmit the coded frame data to a channel.

26. An apparatus, comprising:
a receiver to receive coded frame data from a channel.
a decoding engine to decode the coded frame data according to predictive decoding techniques, and
a post-processor to map values of decoded frame data from a first dynamic range definition to a second dynamic range specific to the apparatus, and
a video sink to render the mapped frame data.
